(19) United States
(12) Patent Application Publication
(10) Pub. No.: US 2026/0077294 A1
(43) Pub. Date: Mar. 19, 2026

(54) ADSORPTION ROTOR AND ADSORPTION AND RECOVERY APPARATUS

(71) Applicant: Taikisha Ltd., Tokyo (JP)

(72) Inventors: Munenori OGUCHI, Tokyo (JP); Keisuke KODERA, Tokyo (JP); Yukinobu KITADA, Tokyo (JP)

(21) Appl. No.: 19/326,503

(22) Filed: Sep. 11, 2025

(30) Foreign Application Priority Data
Sep. 13, 2024 (JP) 2024-159430
Jul. 25, 2025 (JP) 2025-124733

(51) Int. Cl. B01D 53/06

(52) U.S. Cl. CPC B01D 53/06; B01D 2259/4009

(57) ABSTRACT

An adsorption rotor configured of a structure having a ventilation gap carrying an adsorbent and rotating about a central axis, the adsorption rotor including: an adsorption region in which a gas containing a volatile substance to be adsorbed is ventilated and the substance is adsorbed onto the structure; a desorption region on a downstream side in a rotation direction with respect to the adsorption region, through which a desorption gas is ventilated and the adsorbed substance is desorbed; a cooling region on a downstream side with respect to the desorption region, through which a regeneration gas is ventilated and the structure is cooled; a first isolation region between the adsorption region and the desorption region, through which an inert gas is ventilated; and a second isolation region between the cooling region and the adsorption region, through which an inert gas is ventilated.

### CROSS-REFERENCE TO RELATED APPLICATION

This application claims priority under 35 USC 119 from Japanese Patent Applications No. 2024-159430, filed on Sep. 13, 2024, and No. 2025-124733, filed on Jul. 25, 2025, the disclosure of which is incorporated by reference herein.

### BACKGROUND

### Technical Field

The present disclosure relates to an adsorption and recovery apparatus that adsorbs and recovers a volatile substance to be adsorbed by an adsorption rotor composed of a structure having a ventilation gap carrying an adsorbent, and to an adsorption rotor mounted thereon.

### Related Art

Japanese Patent Application Laid-Open (JP-A) No. 2007-44687 and JP-A No. 2007-83238 disclose techniques for continuously separating and recovering an organic compound while enabling safe recovery of a volatile organic compound at a high concentration and preventing pressure fluctuation of a gas system to be treated. Moreover, JP-A No. 2016-77990 discloses a gas treatment apparatus capable of suppressing mixing of gas inside and outside a rotor even in a case in which a treatment air volume and a regeneration air volume are variably controlled without requiring highly accurate processing and adjustment of a sealing material.

### SUMMARY

An object of the technology of the disclosure is to prevent gas leakage and mixing between an adsorption region, and a desorption region and a cooling region, in an adsorption and recovery apparatus that adsorbs and recovers volatile substances to be adsorbed by an adsorption rotor that is configured of a structure having a ventilation gap carrying an adsorbent and has an adsorption region, a desorption region, and a cooling region arranged along a rotation direction.

An aspect of the disclosure is an adsorption rotor configured of a structure having a ventilation gap carrying an adsorbent and rotating in a rotation direction about a central axis, the adsorption rotor including: an adsorption region in which a gas containing a volatile substance to be adsorbed is ventilated and the substance to be adsorbed is adsorbed onto the structure; a desorption region disposed on a downstream side in the rotation direction with respect to the adsorption region, through which a desorption gas is ventilated and the substance to be adsorbed, which is adsorbed onto the structure, is desorbed; a cooling region disposed on a downstream side in the rotation direction with respect to the desorption region, through which a regeneration gas is ventilated and the structure is cooled; a first isolation region provided between the adsorption region and the desorption region, through which an inert gas is ventilated; and a second isolation region provided between the cooling region and the adsorption region, through which an inert gas is ventilated.

According to this aspect, in the adsorption rotor, the first isolation region is interposed between the adsorption region and the desorption region, and moreover, the second isolation region is interposed between the adsorption region and the cooling region. Therefore, mutual gas leakage and mixing between the adsorption region and the desorption region and between the adsorption region and the cooling region can be prevented.

According to the disclosure, it is possible to prevent gas leakage and mixing between an adsorption region, and a desorption region and a cooling region, in an adsorption and recovery apparatus that adsorbs and recovers volatile substances to be adsorbed by an adsorption rotor that is configured of a structure having a ventilation gap carrying an adsorbent and has an adsorption region, a desorption region, and a cooling region arranged along a rotation direction.

### BRIEF DESCRIPTION OF THE DRAWINGS

Exemplary embodiments will be described in detail based on the following figures, wherein:

FIG. 1 is a schematic diagram illustrating a schematic configuration of an adsorption and recovery apparatus according to a first embodiment;

FIG. 2 is a schematic diagram illustrating pressures on an upstream side and a downstream side of a flow path with respect to each region in the adsorption and recovery apparatus of the first embodiment;

FIG. 3 is a block diagram illustrating a hardware configuration of a control unit;

FIG. 4 schematically illustrates a flow of an inert gas in the adsorption and recovery apparatus of FIG. 1;

FIG. 5 schematically illustrates a flow of the inert gas in the adsorption and recovery apparatus of FIG. 1;

FIG. 6 is a schematic diagram illustrating a schematic configuration of an adsorption and recovery apparatus according to the embodiment; and

FIG. 7 is a schematic diagram illustrating a schematic configuration of an adsorption and recovery apparatus according to the embodiment.

### DETAILED DESCRIPTION

Hereinafter, an example of an aspect for implementing the technology of the present disclosure will be described in detail with reference to the drawings. Note that, components and processes whose operations, actions, and functions perform similar functions are denoted by the same reference numerals throughout the drawings, and redundant description may be omitted as appropriate. Each drawing is only schematically illustrated to the extent that the technology of the disclosure can be sufficiently understood. Therefore, the technology of the disclosure is not limited only to the illustrated example. Moreover, in the present embodiment, description of configurations that are not directly related to the technology of the disclosure or well-known configurations may be omitted.

### (1) First Embodiment

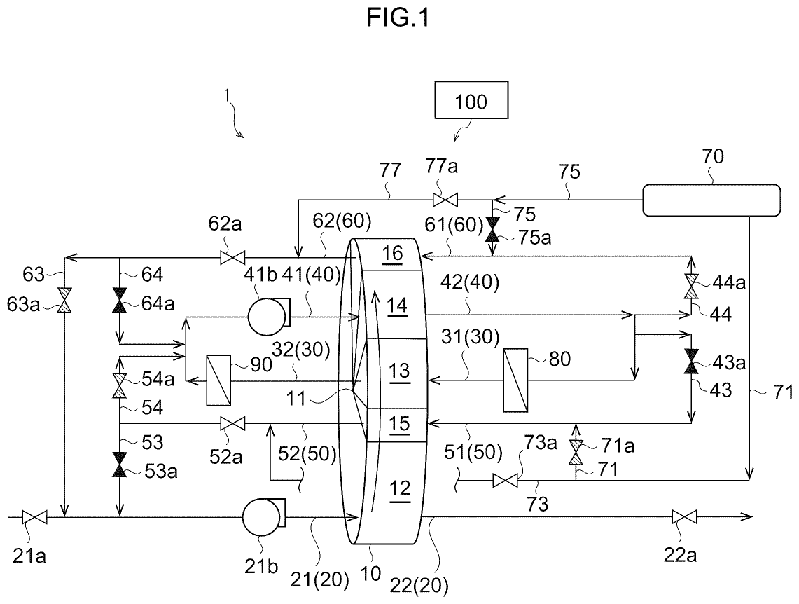

FIG. 1 is a schematic diagram illustrating a schematic configuration of an adsorption and recovery apparatus 1 according to a first embodiment. The adsorption and recovery apparatus 1 of the present embodiment includes an adsorption rotor 10 that is configured of a structure having a ventilation gap carrying an adsorbent and rotates about a central axis 11. The adsorption rotor 10 passes through an adsorption region 12, a first isolation region 15, a desorption region 13, a cooling region 14, and a second isolation region 16 that occupy the largest portion along a rotation direction indicated by an arrow in the drawing.

In the adsorption region 12, gas containing a volatile substance to be adsorbed is ventilated from an upstream side 21 to a downstream side 22 by an adsorption air fan 21b through an adsorption flow path 20, whereby the substance to be adsorbed is adsorbed to the adsorption rotor 10. Note that, in FIG. 1, the adsorption air fan 21b is disposed on the upstream side 21 of the adsorption flow path 20; however, it may be disposed on the downstream side 22, or may be disposed on both the upstream side 21 and the downstream side 22. Examples of the volatile substance to be adsorbed include organic solvents used or generated in a production process or a treatment process of a product. The gas containing the volatile substance to be adsorbed contains oxygen in the atmosphere in the production process or the treatment process. In the adsorption region 12, the adsorption rotor 10 has a relatively low temperature due to cooling in the cooling region 14 to be described later, and the substance to be adsorbed is easily adsorbed.

In the desorption region 13 located on the downstream side in the rotation direction with respect to the adsorption region 12, the heated desorption gas is ventilated from an upstream side 31 to a downstream side 32 through a desorption flow path 30, whereby the adsorbed substance to be adsorbed is desorbed from the adsorption rotor 10. As the desorption gas, an inert gas such as nitrogen is preferable.

In the cooling region 14 located on the downstream side in the rotation direction with respect to the desorption region 13, the cooled regeneration gas is ventilated from an upstream side 41 to a downstream side 42 through a cooling flow path 40, whereby the structure is cooled and the adsorption rotor 10 is regenerated into a state where the substance to be adsorbed can be adsorbed again. As the regeneration gas, an inert gas such as nitrogen is preferable.

Note that, the desorption flow path 30 communicates with the downstream side 42 of the cooling flow path 40 via a heater 80 provided on the upstream side 31, and communicates with the upstream side 41 of the cooling flow path 40 via a cooler 90 provided on the downstream side 32. Namely, the substance to be adsorbed contained in the high-temperature desorption gas desorbed from the adsorption rotor 10 and flowed out from the downstream side 32 of the desorption flow path 30 is cooled by the cooler 90, condensed, and collected as a liquid. The desorption gas from which the substance to be adsorbed is removed becomes a cooled low-temperature regeneration gas, and flows into the cooling region 14 from the upstream side 41 of the cooling flow path 40 by a cooling blower fan 41b. The regeneration gas having cooled the cooling region 14 flows out from the downstream side 42 of the cooling flow path 40, is heated by the heater 80 provided on the upstream side 31 of the desorption flow path 30, becomes a high-temperature desorption gas again, and flows into the desorption region 13 to be used for desorption of the substance to be adsorbed from the adsorption rotor 10.

Between the adsorption region 12 and the desorption region 13, the first isolation region 15 through which an inert gas is ventilated from an upstream side 51 to a downstream side 52 of a first isolation flow path 50 is provided. As the inert gas, it is preferable to use nitrogen. Herein, in the adsorption region 12, oxygen flowing in from the above-described production process or treatment process of the product exists, and this oxygen attempts to flow into the desorption region 13 through the ventilation gap of the structure; however, before that, it reaches the first isolation region 15 disposed between the adsorption region 12 and the desorption region 13, and flows out to the downstream side 52 of the first isolation flow path 50. As a result, the inflow of oxygen from the adsorption region 12 to the desorption region 13 is prevented, so that it is possible to reduce the possibility of inducing an explosion due to the presence of oxygen even in a case where the concentration of the substance to be adsorbed increases on the downstream side 32 of the desorption flow path 30.

Between the cooling region 14 and the adsorption region 12, the second isolation region 16 through which an inert gas is ventilated from an upstream side 61 to a downstream side 62 of a second isolation flow path 60 is provided. As the inert gas, it is preferable to use nitrogen. Herein, in the adsorption region 12, oxygen flowing in from the above-described production process or treatment process of the product process exists, and this oxygen attempts to flow into the cooling region 14 through the ventilation gap of the structure; however, before that, it reaches the second isolation region 16 disposed between the cooling region 14 and the adsorption region 12, and flows out to the downstream side 62 of the second isolation flow path 60. As a result, the inflow of oxygen from the adsorption region 12 to the cooling region 14 is prevented, so that it is possible to avoid mixing of oxygen to the upstream side 31 of the desorption flow path 30 via the downstream side 42 of the cooling flow path 40, and it is possible to reduce the possibility of inducing an explosion due to the presence of oxygen even in a case where the concentration of the substance to be adsorbed increases on the downstream side 32 of the desorption flow path 30. Moreover, it is also possible to prevent a decrease in treatment efficiency due to leakage of the substance to be adsorbed that has not been recovered by the cooler 90 from the desorption flow path 30 to the adsorption region 12 via the cooling region 14 and to the downstream side 22 of the adsorption flow path 20.

Note that, on one side (left side in FIG. 1) with respect to the adsorption rotor 10, the upstream side 21 of the adsorption flow path 20, the downstream side 32 of the desorption flow path 30, the upstream side 41 of the cooling flow path 40, the downstream side 52 of the first isolation flow path 50, and the downstream side 62 of the second isolation flow path 60 are positioned. Moreover, on the other side (right side in FIG. 1) with respect to the adsorption rotor, the downstream side 22 of the adsorption flow path 20, the upstream side 31 of the desorption flow path 30, the downstream side 42 of the cooling flow path 40, the upstream side 51 of the first isolation flow path 50, and the upstream side 61 of the second isolation flow path 60 are positioned.

As described above, the adsorption rotor 10 used in the present embodiment is configured of a structure having a ventilation gap carrying an adsorbent and rotating in a rotation direction about a central axis 11, the adsorption rotor including the adsorption region 12 in which a gas containing a volatile substance to be adsorbed is ventilated and the substance to be adsorbed is adsorbed onto the structure, the desorption region 13 disposed on a downstream side in the rotation direction with respect to the adsorption region 12, through which a desorption gas is ventilated and the substance to be adsorbed, which is adsorbed onto the structure, is desorbed, the cooling region 14 disposed on a downstream side in the rotation direction with respect to the desorption region 13, through which a regeneration gas is ventilated and the structure is cooled, the first isolation region 15 provided between the adsorption region 12 and the desorption region 13, through which an inert gas is ventilated, and the second isolation region 16 provided between the cooling region 14 and the adsorption region 12, through which an inert gas is ventilated.

Moreover, the adsorption and recovery apparatus 1 of the present embodiment includes the above-described adsorption rotor 10, in which the gas containing the volatile substance to be adsorbed is ventilated from one side to another side of the adsorption rotor 10 with respect to the adsorption region 12, the desorption gas is ventilated from the other side to the one side with respect to the desorption region 13, and the regeneration gas is ventilated from the one side to the other side with respect to the cooling region 14.

Furthermore, in the above-described adsorption and recovery apparatus 1, the inert gas is ventilated from the other side to the one side with respect to the first isolation region 15, and the inert gas is ventilated from the other side to the one side with respect to the second isolation region 16.

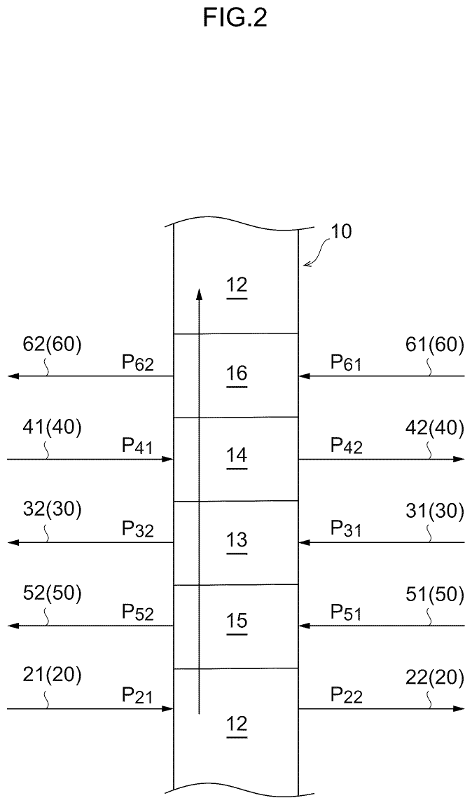

FIG. 2 is a schematic diagram illustrating pressures on an upstream side and a downstream side of a flow path with respect to each region in the adsorption and recovery apparatus 1 of the present embodiment. As illustrated in the drawing, in the adsorption flow path 20, the pressure on the upstream side 21 with respect to the adsorption region 12 is defined as P₂₁, and the pressure on the downstream side 22 is defined as P₂₂. Moreover, in the desorption flow path 30, the pressure on the upstream side 31 with respect to the desorption region 13 is defined as P₃₁, and the pressure on the downstream side 32 is defined as P₃₂. Furthermore, in the cooling flow path 40, the pressure on the upstream side 41 with respect to the cooling region 14 is defined as P₄₁, and the pressure on the downstream side 42 is defined as P₄₂. Moreover, in the first isolation flow path 50, the pressure on the upstream side 51 with respect to the first isolation region 15 is defined as P₅₁, and the pressure on the downstream side 52 is defined as P₅₂. Furthermore, in the second isolation flow path 60, the pressure on the upstream side 61 with respect to the second isolation region 16 is defined as P₆₁ and the pressure on the downstream side 62 is defined as P₆₂.

Then, the adsorption and recovery apparatus 1 of the present embodiment includes a control unit 100 (see FIG. 1) that adjusts the pressures of the adsorption flow path 20, the cooling flow path 40, the first isolation flow path 50, and the second isolation flow path 60 such that the above-described pressures satisfy P₅₁>P₂₁, P₅₁>P₂₂, P₅₂>P₂₁, P₅₂>P₂₂, P₆₁<P₄₂, P₆₁<P₂₂, P₆₂<P₄₁, and P₆₂<P₂₁. Details of the control unit 100 will be described later.

Namely, by satisfying P₅₁>P₂₁, P₅₁>P₂₂, P₅₂>P₂₁, and P₅₂>P₂₂, it is possible to prevent the gas containing oxygen from leaking from the adsorption region 12 to the desorption region 13 by the first isolation region 15.

Moreover, since P₆₁<P₄₂ and P₆₂<P₄₁, gas leaks from the cooling region 14 toward the second isolation region 16. Moreover, since P₆₁<P₂₂ and P₆₂<P₂₁, the gas containing oxygen leaks from the adsorption region 12 to the second isolation region 16. As a result, leakage of a gas containing oxygen from the adsorption region 12 to the cooling region 14 via the second isolation region 16 and leakage of a gas containing a substance to be adsorbed from the cooling region 14 to the adsorption region 12 can be prevented by the second isolation region 16.

In other words, in the above-described adsorption and recovery apparatus 1, the control unit 100 that controls a pressure of the first isolation region 15 to be higher than a pressure of the adsorption region 12, and a pressure of the second isolation region 16 to be lower than pressures of the cooling region 14 and the adsorption region 12 is provided.

Furthermore, as illustrated in FIG. 1, the adsorption and recovery apparatus 1 of the present embodiment further includes an inert gas supply source 70 that supplies an inert gas, a first supply path 71 that communicates the inert gas supply source 70 with the upstream side 51 of the first isolation flow path 50, a first supply valve 71a that is a valve provided in the middle of the first supply path 71, a second supply path 75 that communicates the inert gas supply source 70 with the upstream side 61 of the second isolation flow path 60, a second supply valve 75a that is a valve provided in the middle of the second supply path 75, a first circulation flow path 53 that communicates the downstream side 52 of the first isolation flow path 50 with the upstream side 21 of the adsorption flow path 20, a first circulation valve 53a that is a valve provided in the middle of the first circulation flow path 53, a first replenishment path 54 that communicates the downstream side 52 of the first isolation flow path 50 with the upstream side 41 of the cooling flow path 40, a first replenishment valve 54a that is a valve provided in the middle of the first replenishment path 54, a second circulation flow path 63 that communicates the downstream side 62 of the second isolation flow path 60 with the upstream side 21 of the adsorption flow path 20, a second circulation valve 63a that is a valve provided in the middle of the second circulation flow path 63, a second replenishment path 64 that communicates the downstream side 62 of the second isolation flow path 60 with the upstream side 41 of the cooling flow path 40, a second replenishment valve 64a that is a valve provided in the middle of the second replenishment path 64, a first recovery path 43 that communicates the downstream side 42 of the cooling flow path 40 with the upstream side 51 of the first isolation flow path 50, a first recovery valve 43a that is a valve provided in the middle of the first recovery path 43, a second recovery path 44 that communicates a downstream side 42 of the cooling flow path 40 with an upstream side 61 of the second isolation flow path 60, and a second recovery valve 44a that is a valve provided in the middle of the second recovery path 44.

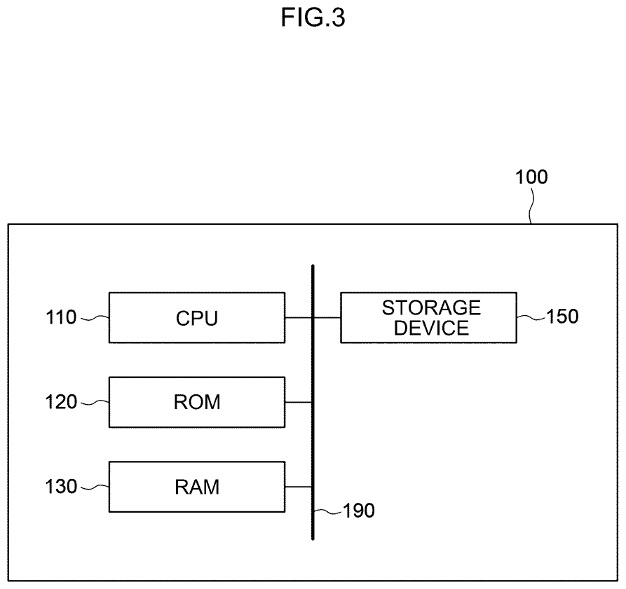

As illustrated in the hardware configuration of FIG. 3, the control unit 100 includes a central processing unit (CPU) 110, a read only memory (ROM) 120, a random access memory (RAM) 130, and a storage device 150. The respective configurations are communicably connected to each other via a bus 190.

The CPU 110 is a central processing unit, and executes various programs that can be realized as an installed application and controls each unit. Namely, the CPU 110 reads out the program from the ROM 120 or the storage device 150, and executes the program using the RAM 130 as a work area. The CPU 110 opens and closes each valve in accordance with the program recorded in the ROM 120 or the storage device 150.

The ROM 120 stores various programs and various data. The RAM 130 temporarily stores programs or data as a work area. The storage device 150 is configured as a storage by a hard disk drive (HDD), a solid state drive (SSD), or a flash memory, and stores various programs including an operating system and various data.

Then, in order to implement the magnitude relationship among P₂₁, P₂₂, P₄₁, P₄₂, P₅₁, P₅₂, P₆₁, and P₆₂ as described above, the control unit 100 synchronously opens and closes the hatched first supply valve 71a, first replenishment valve 54a, second circulation valve 63a, and second recovery valve 44a (the four valves described above are referred to as a “first valve group”) in the drawing, and moreover, synchronously opens and closes the black second supply valve 75a, first circulation valve 53a, second replenishment valve 64a, and first recovery valve 43a (the four valves described above are referred to as a “second valve group”) in the drawing. Note that, one of the first valve group and the second valve group may be opened and moreover, the other may be closed, or both may be opened.

Note that, in the adsorption and recovery apparatus 1 of the present embodiment, an adsorption inflow valve 21a that opens and closes the upstream side 21 of the adsorption flow path 20, an adsorption outflow valve 22a that opens and closes the downstream side 22 of the adsorption flow path, a first isolation outflow valve 52a that opens and closes the downstream side 52 of the first isolation flow path 50, a second isolation outflow valve 62a that opens and closes the downstream side 62 of the second isolation flow path 60, a first bypass valve 73a that opens and closes a first bypass 73, which is a bypass from the first supply path 71 to the downstream side 52 of the first isolation flow path 50, and a second bypass valve 77a that opens and closes a second bypass 77, which is a bypass from the second supply path 75 to the downstream side 62 of the second isolation flow path 60, which are indicated in white in the drawing, are further provided. Each of these valves is appropriately opened and closed to fill each flow path with an inert gas and adjust the pressure of each flow path.

For example, in a case where it is desired to lower the pressure P₂₂ on the downstream side 22 of the adsorption flow path 20, it is conceivable to perform an operation of opening the adsorption outflow valve 22a and reducing the operation speed of the adsorption air fan 21b. Moreover, in a case where it is desired to lower the pressure P₅₁ on the upstream side 51 of the first isolation flow path 50, in a case where it is desired to increase the pressure P₅₂ on the downstream side 52, or in a case where it is desired to fill the downstream side 52 with an inert gas, the first bypass valve 73a of the first bypass 73 is opened. Further, in a case where it is desired to lower the pressure P₆₁ on the upstream side 61 of the second isolation flow path 60, in a case where it is desired to increase the pressure P₆₂ on the downstream side 62, or in a case where it is desired to fill the downstream side 62 with the inert gas, the second bypass valve 77a of the second bypass 77 is opened.

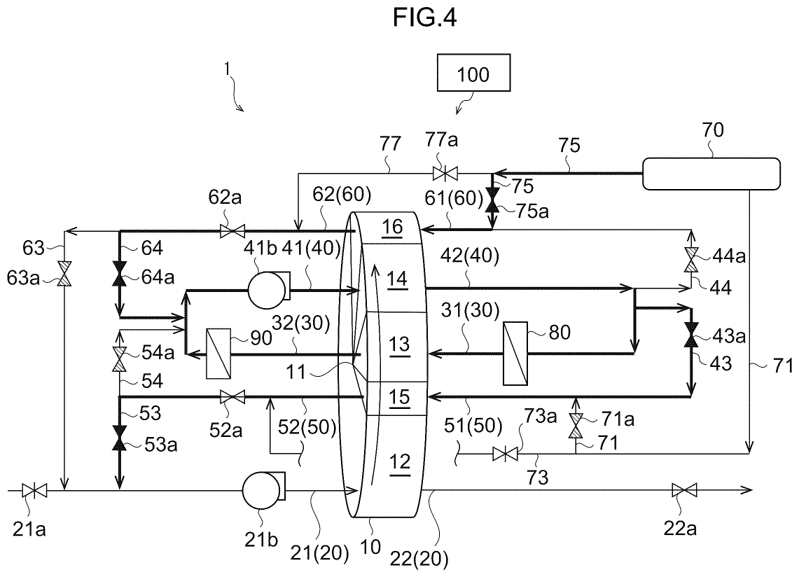

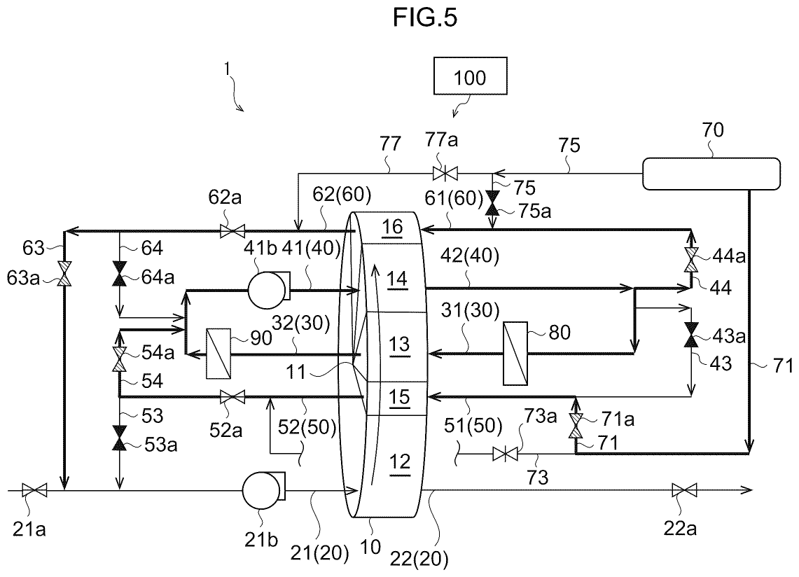

FIG. 4 is a schematic diagram illustrating a flow of an inert gas in a state where the above-described first valve group (hatched valve in the drawing) is closed and the second valve group (black valve in the drawing) is opened. Moreover, FIG. 5 is a schematic diagram illustrating a flow of an inert gas in a state where the first valve group is opened and the second valve group is closed. Note that, in FIGS. 4 and 5, among the white valves, a valve to which a straight line along the flow path is added indicates an open valve, and a valve to which a straight line perpendicular to the flow path is added indicates a closed valve.

The opened/closed states of the valve illustrated in FIG. 4 are mainly executed in a case where each flow path is filled with an inert gas when the adsorption and recovery apparatus 1 is started up. Herein, the inert gas passes through a flow path indicated by a thick line. The inert gas from the inert gas supply source 70 reaches the upstream side 61 of the second isolation flow path 60 from the second supply path 75 via the opened second supply valve 75a, and reaches the downstream side 62 through the second isolation region 16. Next, the inert gas reaches the upstream side 41 of the cooling flow path 40 from the second replenishment path 64 via the opened second replenishment valve 64a, and reaches the downstream side 42 through the cooling region 14.

The inert gas reaches the desorption flow path 30 and the first isolation flow path 50 along the branched flow path from the downstream side 42 of the cooling region 14. The inert gas having reached the desorption flow path 30 is heated by the heater 80 on the upstream side 31, then reaches the downstream side 32 through the desorption region 13, and reaches the upstream side 41 of the cooling region 14 again. On the other hand, the inert gas having reached the first isolation flow path 50 passes through the opened first recovery valve 43a and reaches the downstream side 52 from the upstream side 51 through the first isolation region 15 and further passes through the opened first circulation valve 53a and reaches the upstream side 21 of the adsorption flow path 20 from the first circulation flow path 53.

In the state of FIG. 4, the flow path circulating through the desorption flow path 30 passing through the desorption region 13 and the cooling flow path 40 passing through the cooling region 14 is filled with the inert gas.

The open/close states of the valve illustrated in FIG. 5 are mainly executed in a case where the adsorption and recovery apparatus 1 is operating in a state where each flow path is filled with an inert gas. Herein, the inert gas passes through a flow path indicated by a thick line. In the state illustrated in this drawing, the adsorption inflow valve 21a on the upstream side 21 of the adsorption flow path 20 is opened, and a gas containing a volatile substance to be adsorbed flows into the adsorption flow path 20 from a production process or treatment process of the product. The inert gas from the inert gas supply source 70 reaches the upstream side 51 of the first isolation flow path 50 from the first supply path 71 via the opened first supply valve 71a, and reaches the downstream side 52 through the first isolation region 15. Next, the inert gas reaches the upstream side 41 of the cooling flow path 40 from the first replenishment path 54 via the opened first replenishment valve 54a, and reaches the downstream side 42 through the cooling region 14.

The inert gas reaches the desorption flow path 30 and the second isolation flow path 60 along the branched flow path from the downstream side 42 of the cooling flow path 40. The inert gas having reached the desorption flow path 30 reaches the downstream side 32 while containing the substance to be adsorbed that has been desorbed through the desorption region 13 after being heated by the heater 80 on the upstream side 31 is cooled by the cooler 90 to cause the substance to be adsorbed to adhere and be removed, and reaches the upstream side 41 of the cooling region 14 again in a cooled state to regenerate the structure of the adsorption rotor 10. On the other hand, the inert gas having reached the second isolation flow path 60 passes through the opened second recovery valve 44a and reaches the downstream side 62 from the upstream side 61 through the second isolation region 16 and further passes through the opened second circulation valve 63a and reaches the upstream side 21 of the adsorption flow path 20 from the second circulation flow path 63, joins the gas containing the volatile substance to be adsorbed, and reaches the downstream side 22 while causing the adsorption rotor 10 to adsorb the substance to be adsorbed while passing through the adsorption region 12.

In the state of FIG. 5, the pressure P₅₁ on the upstream side 51 and the pressure P₅₂ on the downstream side 52 of the first isolation flow path 50 located on the most upstream side from the inert gas supply source 70 (see FIG. 2) are made relatively high, and the pressure P₆₁ on the upstream side 61 and the pressure P₆₂ on the downstream side 62 of the second isolation flow path 60 located on the further downstream side of one of the flow paths branched from the downstream side 42 of the cooling flow path 40 located on the downstream side (see FIG. 2) are made lowest. Thereby, it is possible to prevent the gas containing oxygen from leaking from the adsorption region 12 to the desorption region 13 by the first isolation region 15. Moreover, since P₆₁<P₄₂ and P₆₂<P₄₁, gas leaks from the cooling region 14 toward the second isolation region 16, and since P₆₁<P₂₂ and P₆₂<P₂₁, gas containing oxygen leaks from the adsorption region 12 to the second isolation region 16. As a result, leakage of a gas containing oxygen from the adsorption region 12 to the cooling region 14 via the second isolation region 16 and leakage of a gas containing a substance to be adsorbed from the cooling region 14 to the adsorption region 12 can be prevented by the second isolation region 16.

Herein, the desorption flow path 30 and the cooling flow path 40 form a circulation flow path as described above. However, since the inert gas flows into the circulation flow path via the first replenishment path 54, the inert gas in the circulation flow path is reduced, and the pressure P₃₁ on the upstream side 31 and the pressure P₃₂ on the downstream side 32 of the desorption flow path 30, and the pressure P₄₁ on the upstream side 41 and the pressure P₄₂ on the downstream side of the cooling flow path 40 (see FIG. 2) do not decrease. Moreover, when the pressure balance in each flow path is lost, it is possible to appropriately switch the open/close states of each valve to appropriately refill each flow path with an inert gas and adjust the pressure.

As described above, the adsorption and recovery apparatus 1 according to the present embodiment includes the adsorption rotor 10 that is configured of a structure having a ventilation gap carrying an adsorbent and rotates in a rotation direction about a central axis, the adsorption region 12 in which a gas containing a volatile substance to be adsorbed is ventilated through the adsorption flow path 20 and the substance to be adsorbed is adsorbed in the adsorption rotor 10, the desorption region 13 that is located on the downstream side in the rotation direction with respect to the adsorption region 12 and from which the substance to be adsorbed is desorbed by being ventilated with a heated desorption gas through the desorption flow path 30, the cooling region 14 that is located on the downstream side in the rotation direction with respect to the desorption region 13 and from which the structure is cooled by being ventilated with a cooled regeneration gas through the cooling flow path 40, the first isolation region 15 that is provided between the adsorption region 12 and the desorption region 13, through which an inert gas is ventilated through the first isolation flow path 50, and the second isolation region 16 that is provided between the cooling region 14 and the adsorption region 12, through which an inert gas is ventilated through the second isolation flow path 60.

Moreover, the adsorption and recovery apparatus 1 of the present embodiment further includes the cooler 90 that cools the substance to be adsorbed contained in the desorption gas that has passed through the desorption region 13, and the heater 80 that heats the regeneration gas that has passed through the cooling region 14.

Moreover, in the adsorption and recovery apparatus 1 of the present embodiment, the regeneration gas cooled by the cooler 90 is supplied to the cooling region 14, and the desorption gas heated by the heater 80 is supplied to the desorption region 13.

Furthermore, in the adsorption and recovery apparatus 1 of the present embodiment, the inert gas supply source 70 that supplies the inert gas, the first supply path 71 that communicates the inert gas supply source 70 with the upstream side of the first isolation flow path 50, the first supply valve 71a that is provided in the middle of the first supply path 71, the second supply path 75 that communicates the inert gas supply source 70 with the upstream side of the second isolation flow path 60, the second supply valve 75a that is provided in the middle of the second supply path 75, the first circulation flow path 53 that communicates the downstream side of the first isolation flow path 50 with the upstream side of the adsorption flow path 20, the first circulation valve 53a that is provided in the middle of the first circulation flow path 53, the first replenishment path 54 that communicates the downstream side of the first isolation flow path 50 with the upstream side of the cooling flow path 40, the first replenishment valve 54a that is provided in the middle of the first replenishment path 54, the second circulation flow path 63 that communicates the downstream side of the second isolation flow path 60 with the upstream side of the adsorption flow path 20, the second circulation valve 63a that is provided in the middle of the second circulation flow path 63, the second replenishment path 64 that communicates the downstream side of the second isolation flow path 60 with the upstream side of the cooling flow path 40, the second replenishment valve 64a that is provided in the middle of the second replenishment path 64, the first recovery path 43 that communicates the downstream side of the cooling flow path 40 with the upstream side of the first isolation flow path 50, the first recovery valve 43a that is provided in the middle of the first recovery path 43, the second recovery path 44 that communicates the downstream side of the cooling flow path 40 with the upstream side of the second isolation flow path 60, and the second recovery valve 44a that is provided in the middle of the second recovery path 44 are further provided, in which the control unit 100 opens and closes the first supply valve 71a, the first replenishment valve 54a, the second circulation valve 63a, and the second recovery valve 44a in synchronization, and opens and closes the second supply valve 75a, the first circulation valve 53a, the second replenishment valve 64a, and the first recovery valve 43a in synchronization.

### (2) Second Embodiment

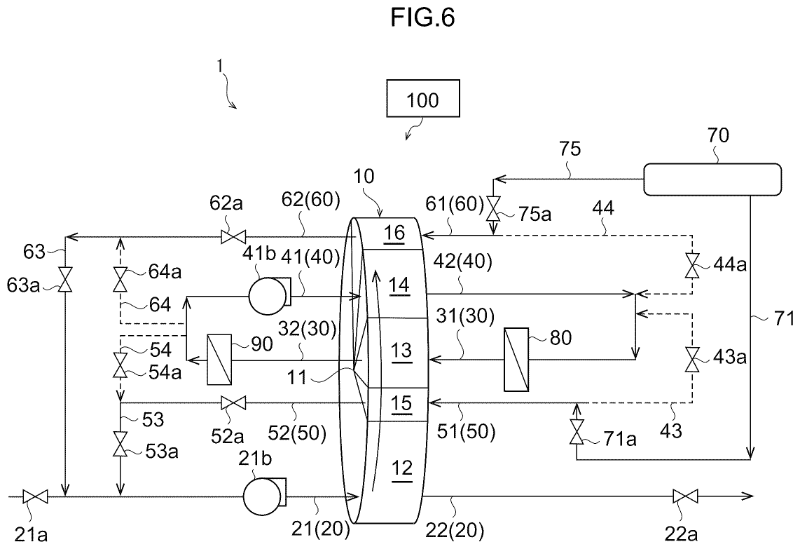

FIG. 6 is a schematic diagram illustrating a schematic configuration of the adsorption and recovery apparatus 1 according to a second embodiment. A configuration of the adsorption and recovery apparatus 1 of the present embodiment is the same as the configuration of the first embodiment except that the first bypass 73 and the second bypass 77 are removed from the first embodiment illustrated in FIG. 1.

In the present embodiment, when the adsorption and recovery apparatus 1 is started up, the circulation flow path between the desorption flow path 30 and the cooling flow path 40 can be quickly filled with an inert gas. Namely, in a state where the first isolation outflow valve 52a of the first isolation flow path 50 and the second isolation outflow valve 62a of the second isolation flow path 60 are closed and all the other valves are opened, the inert gas can be supplied from the inert gas supply source 70 to the desorption flow path 30 and the cooling flow path 40 through the first supply path 71 and the first recovery valve 43a of the first recovery path 43, and through the second supply path 75 and the second recovery valve 44a of the second recovery path 44 to be filled with the inert gas.

The behavior of each valve and the movement of the inert gas in the operating state of the adsorption and recovery apparatus 1 of the present embodiment are different from those of the first embodiment in that the inert gas is directly supplied from the inert gas supply source 70 to the first isolation flow path 50 and the second isolation flow path 60. Among the valves illustrated in FIG. 6, the first recovery valve 43a of the first recovery path 43, the second recovery valve 44a of the second recovery path 44, the first replenishment valve 54a of the first replenishment path 54, and the second replenishment valve 64a of the second replenishment path 64 are closed, and all the other valves are opened. The present embodiment is assumed to be performed in a case where the supply pressure of the inert gas supplied from the inert gas supply source 70 is low, the pressure P₅₁ on the upstream side 51 and the pressure P₅₂ on the downstream side 52 of the first isolation flow path 50, and the pressure P₆₁ on the upstream side 61 and the pressure P₆₂ on the downstream side 62 of the second isolation flow path 60 are relatively low. Namely, unlike the first embodiment, it is assumed that the pressures in the first isolation region 15 satisfy P₅₁<P₂₁, P₅₁<P₂₂, P₅₂<P₂₁, and P₅₂<P₂₂, and the pressures in the second isolation region 16 satisfy P₆₁<P₄₂, P₆₁<P₂₂, P₆₂<P₄₁, and P₆₂<P₂₁. In this case, the gas containing oxygen leaks from the adsorption region 12 to the first isolation region 15, and the gas leaks from the desorption region 13 toward the first isolation region 15. As a result, leakage of a gas containing oxygen from the adsorption region 12 to the desorption region 13 via the first isolation region 15 and leakage of a gas containing a high concentration of a substance to be adsorbed from the desorption region 13 to the adsorption region 12 can be prevented by the first isolation region 15. Moreover, the gas containing oxygen leaks from the adsorption region 12 to the second isolation region 16, and the gas leaks from the cooling region 14 toward the second isolation region 16. As a result, leakage of a gas containing oxygen from the adsorption region 12 to the cooling region 14 via the second isolation region 16 and leakage of a gas containing a substance to be adsorbed from the cooling region 14 to the adsorption region 12 can be prevented by the second isolation region 16.

### (3) Third Embodiment

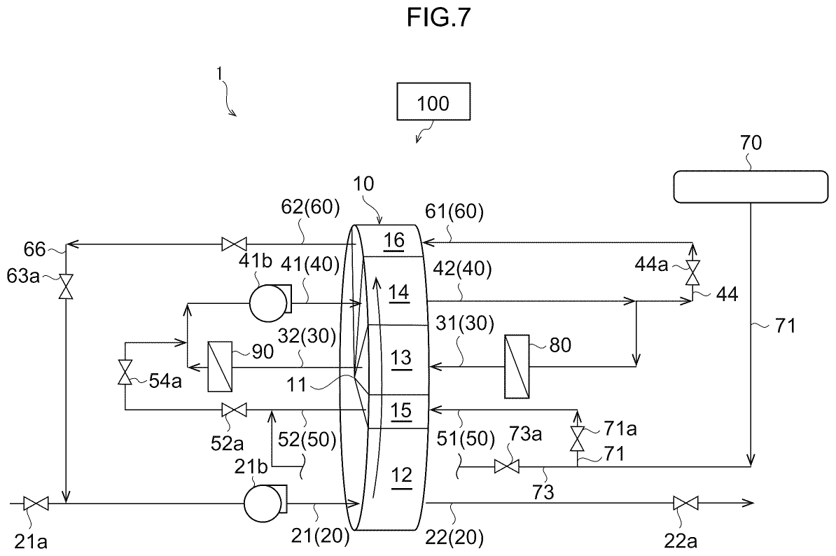

FIG. 7 is a schematic diagram illustrating a schematic configuration of the adsorption and recovery apparatus 1 according to a third embodiment. The adsorption and recovery apparatus 1 of the present embodiment is different from the first embodiment and the second embodiment provided with a supply path through which the inert gas is directly supplied also to the second isolation flow path 60 in that the inert gas from the inert gas supply source 70 is directly supplied only to the first isolation flow path 50.

Among the valves illustrated in FIG. 7, in a state where the first bypass valve 73a of the first bypass 73 is closed and all the other valves are opened, the inert gas from the inert gas supply source 70 reaches the upstream side 51 of the first isolation flow path 50 from the first supply path 71 via the opened first supply valve 71a, and reaches the downstream side 52 through the first isolation region 15. Next, the inert gas reaches the upstream side 41 of the cooling flow path 40 from the first replenishment path 54 via the opened first replenishment valve 54a, and reaches the downstream side 42 through the cooling region 14.

The inert gas reaches the desorption flow path 30 and the second isolation flow path 60 along the branched flow path from the downstream side 42 of the cooling flow path 40. The inert gas having reached the desorption flow path 30 is heated by the heater 80 on the upstream side 31, passes through the desorption region 13 while containing the adsorbate that has been desorbed, and reaches the downstream side 32. The inert gas is then cooled by the cooler 90 so that the adsorbate is condensed and removed, and in the cooled state, it reaches the upstream side 41 of the cooling region 14 again to regenerate the adsorption rotor 10. On the other hand, the inert gas having reached the second isolation flow path 60 passes through the opened second recovery valve 44a, passes from the upstream side 61 to the downstream side 62 via the second isolation region 16, and further passes through the opened second circulation valve 63a to reach the upstream side 21 of the adsorption flow path 20 from the second circulation flow path 63, joins the gas containing the volatile substance to be adsorbed, and, while passing through the adsorption region 12, causes the adsorption rotor 10 to adsorb the substance to be adsorbed, and reaches the downstream side 22.

In the state of FIG. 7, the pressure P₅₁ on the upstream side 51 and the pressure P₅₂ on the downstream side 52 of the first isolation flow path 50 at the position closest to the inert gas supply source 70 (see FIG. 2) are relatively high, and the pressure P₆₁ on the upstream side 61 and the pressure P₆₂ on the downstream side 62 of the second isolation flow path 60 located further downstream of one of the flow paths branched from the downstream side 42 of the cooling flow path 40 (see FIG. 2) are the lowest.

What is claimed is:

1. An adsorption rotor configured of a structure having a ventilation gap carrying an adsorbent and rotating in a rotation direction about a central axis, the adsorption rotor comprising:
an adsorption region in which a gas containing a volatile substance to be adsorbed is ventilated and the substance to be adsorbed is adsorbed onto the structure;
a desorption region disposed on a downstream side in the rotation direction with respect to the adsorption region, through which a desorption gas is ventilated and the substance to be adsorbed, which is adsorbed onto the structure, is desorbed;
a cooling region disposed on a downstream side in the rotation direction with respect to the desorption region, through which a regeneration gas is ventilated and the structure is cooled;
a first isolation region provided between the adsorption region and the desorption region, through which an inert gas is ventilated; and
a second isolation region provided between the cooling region and the adsorption region, through which an inert gas is ventilated.

2. An adsorption and recovery apparatus comprising:
the adsorption rotor according to claim 1, wherein:
the gas containing the volatile substance to be adsorbed is ventilated from one side to another side of the adsorption rotor with respect to the adsorption region,
the desorption gas is ventilated from the other side to the one side with respect to the desorption region, and
the regeneration gas is ventilated from the one side to the other side with respect to the cooling region.

3. The adsorption and recovery apparatus according to claim 2, wherein:
the inert gas is ventilated from the other side to the one side with respect to the first isolation region, and
the inert gas is ventilated from the other side to the one side with respect to the second isolation region.

4. The adsorption and recovery apparatus according to claim 2, comprising:
a control unit that controls a pressure of the first isolation region to be higher than a pressure of the adsorption region, and a pressure of the second isolation region to be lower than pressures of the cooling region and the adsorption region.

5. The adsorption and recovery apparatus according to claim 2, wherein:
on the one side with respect to the adsorption rotor, an upstream side of an adsorption flow path for ventilation to the adsorption region, a downstream side of a desorption flow path for ventilation to the desorption region, an upstream side of a cooling flow path for ventilation to the cooling region, a downstream side of a first isolation flow path for ventilation to the first isolation region, and a downstream side of a second isolation flow path for ventilation to the second isolation region are positioned,
on the other side with respect to the adsorption rotor, a downstream side of the adsorption flow path, an upstream side of the desorption flow path, a downstream side of the cooling flow path, an upstream side of the first isolation flow path, and an upstream side of the second isolation flow path are positioned, and
when, in the adsorption flow path, a pressure on an upstream side with respect to the adsorption region is defined as P₂₁ and a pressure on a downstream side with respect to the adsorption region is defined as P₂₂,
in the cooling flow path, a pressure on the upstream side with respect to the cooling region is defined as P₄₁ and a pressure on the downstream side with respect to the cooling region is defined as P₄₂,
in the first isolation flow path, a pressure on the upstream side with respect to the first isolation region is defined as P₅₁ and a pressure on the downstream side with respect to the first isolation region is defined as P₅₂, and
in the second isolation flow path, a pressure on the upstream side with respect to the second isolation region is defined as P₆₁ and a pressure on the downstream side with respect to the second isolation region is defined as P₆₂,
a control unit is provided to control pressures in the adsorption flow path, the cooling flow path, the first isolation flow path, and the second isolation flow path such that:
$${P}_{51} > {P}_{21} ,$$
$${P}_{51} > {P}_{22} ,$$
$${P}_{52} > {P}_{21} ,$$
$${P}_{52} > {P}_{22} ,$$
$${P}_{61} < {P}_{42} ,$$
$${P}_{61} < {P}_{22} ,$$
$${P}_{62} < {P}_{41} , and$$
$${P}_{62} < {P}_{21} .$$

6. The adsorption and recovery apparatus according to claim 2, wherein:
on the one side with respect to the adsorption rotor, an upstream side of an adsorption flow path for ventilation to the adsorption region, a downstream side of a desorption flow path for ventilation to the desorption region, an upstream side of a cooling flow path for ventilation to the cooling region, a downstream side of a first isolation flow path for ventilation to the first isolation region, and a downstream side of a second isolation flow path for ventilation to the second isolation region are positioned,
on the other side with respect to the adsorption rotor, a downstream side of the adsorption flow path, an upstream side of the desorption flow path, a downstream side of the cooling flow path, an upstream side of the first isolation flow path, and an upstream side of the second isolation flow path are positioned, and
when, in the adsorption flow path, a pressure on an upstream side with respect to the adsorption region is defined as P₂₁ and a pressure on a downstream side with respect to the adsorption region is defined as P₂₂,
in the cooling flow path, a pressure on the upstream side with respect to the cooling region is defined as P₄₁ and a pressure on the downstream side with respect to the cooling region is defined as P₄₂,
in the first isolation flow path, a pressure on the upstream side with respect to the first isolation region is defined as P₅₁ and a pressure on the downstream side with respect to the first isolation region is defined as P₅₂, and
in the second isolation flow path, a pressure on the upstream side with respect to the second isolation region is defined as P₆₁ and a pressure on the downstream side with respect to the second isolation region is defined as P₆₂,
a control unit is provided to control pressures in the adsorption flow path, the cooling flow path, the first isolation flow path, and the second isolation flow path such that:
$${P}_{51} < {P}_{21} ,$$
$${P}_{51} < {P}_{22} ,$$
$${P}_{52} < {P}_{21} ,$$
$${P}_{52} < {P}_{22} ,$$
$${P}_{61} < {P}_{42} ,$$
$${P}_{61} < {P}_{22} ,$$
$${P}_{62} < {P}_{41} , and$$
$${P}_{62} < {P}_{21} .$$

7. The adsorption and recovery apparatus according to claim 2, further comprising: a cooler that cools the substance to be adsorbed contained in the desorption gas that has passed through the desorption region; and
a heater that heats the regeneration gas that has passed through the cooling region.

8. The adsorption and recovery apparatus according to claim 7, wherein the regeneration gas cooled by the cooler is supplied to the cooling region, and the desorption gas heated by the heater is supplied to the desorption region.

9. The adsorption and recovery apparatus according to claim 6, further comprising:
an inert gas supply source that supplies the inert gas;
a first supply path that communicates the inert gas supply source with the upstream side of the first isolation flow path;
a first supply valve that is provided in a middle of the first supply path;
a second supply path that communicates the inert gas supply source with the upstream side of the second isolation flow path;
a second supply valve that is provided in a middle of the second supply path;
a first circulation flow path that communicates the downstream side of the first isolation flow path with the upstream side of the adsorption flow path;
a first circulation valve that is provided in a middle of the first circulation flow path;
a first replenishment path that communicates the downstream side of the first isolation flow path with the upstream side of the cooling flow path;
a first replenishment valve that is provided in a middle of the first replenishment path;
a second circulation flow path that communicates the downstream side of the second isolation flow path with the upstream side of the adsorption flow path;
a second circulation valve that is provided in a middle of the second circulation flow path;
a second replenishment path that communicates the downstream side of the second isolation flow path with the upstream side of the cooling flow path;
a second replenishment valve that is provided in a middle of the second replenishment path;
a first recovery path that communicates the downstream side of the cooling flow path with the upstream side of the first isolation flow path;
a first recovery valve that is provided in a middle of the first recovery path;
a second recovery path that communicates the downstream side of the cooling flow path with the upstream side of the second isolation flow path; and
a second recovery valve that is provided in a middle of the second recovery path,
wherein the control unit:
opens and closes the first supply valve, the first replenishment valve, the second circulation valve, and the second recovery valve in synchronization, and
opens and closes the second supply valve, the first circulation valve, the second replenishment valve, and the first recovery valve in synchronization.
